(19) United States
(12) Patent Application Publication
(10) Pub. No.: US 2026/0222984 A1
(43) Pub. Date: Jul. 30, 2026

(54) METHOD AND APPARATUS FOR DETERMINING TRANSMITTER AND/OR RECEIVER, AND COMMUNICATION DEVICE

(71) Applicant: Beijing Xiaomi Mobile Software Co., Ltd., Beijing (CN)

(72) Inventors: Yang SHEN, Beijing (CN); Jianning LIU, Beijing (CN)

(73) Assignee: Beijing Xiaomi Mobile Software Co., Ltd., Beijing (CN)

(21) Appl. No.: 19/145,756

(22) PCT Filed: Jan. 3, 2023
(86) PCT No.: PCT/CN2023/070239

§ 371 Date: Jul. 3, 2025

(51) Int. Cl. H04W 48/20

(52) U.S. Cl. CPC H04W 48/20

(57) ABSTRACT

A method, apparatus, and computer-readable medium are disclosed for determining at least one of a transmitter or a receiver for a sensing service in a wireless communication system. The method is performed by a network function and includes determining, based on a service relationship between a terminal and a base station, the roles of transmitter and/or receiver for performing the sensing service. The service relationship may include whether the base station is a serving base station of the terminal and whether the terminal is within the base station's signal coverage. Depending on the determined relationship, the network function can assign the terminal and the base station as transmitters, receivers, or both, and may prioritize selection based on service association and signal coverage.

### CROSS REFERENCE TO RELATED APPLICATIONS

The present application is a U.S. National Stage of International Application No. PCT/CN2023/070239, filed on Jan. 3, 2023, all contents of which are incorporated herein by reference in their entirety for all purposes.

### TECHNICAL FIELD

The present disclosure relates to the field of wireless communication technology, but is not limited to the field of wireless communication technology, and in particular, to a method and apparatus for determining a transmitter and/or a receiver for a sensing service, a communication device, and a storage medium.

### BACKGROUND

The wireless sensing technology is intended to obtain information about a target object and environment features of the target object by using the wireless communication technology (for example, E-UTRA, 5G NR, WiFi, Bluetooth, etc.), where the information about the target object and the environmental features of the target object include features such as shape, size, speed, position, distance, or relative motion between objects.

### SUMMARY

According to a first aspect of the embodiments of the present disclosure, there is provided a method for determining a transmitter and/or a receiver for a sensing service, where the method is performed by a network function, and the method includes:
determining, based on a service relationship between a terminal and a base station, a transmitter and/or a receiver for performing a sensing service.

According to a second aspect of the embodiments of the present disclosure, there is provided a communication device, including:
a processor; and
a memory, configured to store an executable instruction by the processor;
where the processor is configured to, when running the executable instruction, implement the method according to any embodiment of the present disclosure.

According to a third aspect of the embodiments of the present disclosure, there is provided a non-transitory computer storage medium, where the non-transitory computer storage medium stores a computer executable program, and when the executable program is executed by a processor, the method according to any embodiment of the present disclosure is implemented.

### BRIEF DESCRIPTION OF THE DRAWINGS

FIG. 1 is a schematic structural diagram of a wireless communication system shown according to some embodiments of the present disclosure.

FIG. 2 is a schematic diagram of the processing of a sensing service shown according to some embodiments of the present disclosure.

FIG. 3 is a schematic diagram of the processing of a sensing service shown according to some embodiments of the present disclosure.

FIG. 4 is a schematic diagram of the processing of a sensing service shown according to some embodiments of the present disclosure.

FIG. 5 is a schematic diagram of the processing of a sensing service shown according to some embodiments of the present disclosure.

FIG. 6 is a schematic diagram of the processing of a sensing service shown according to some embodiments of the present disclosure.

FIG. 7 is a schematic diagram of the processing of a sensing service shown according to some embodiments of the present disclosure.

FIG. 8 is a schematic diagram of the processing of a sensing service shown according to some embodiments of the present disclosure.

FIG. 9 is a schematic diagram of the processing of a sensing service shown according to some embodiments of the present disclosure.

FIG. 10 is a schematic diagram of the processing of a sensing service shown according to some embodiments of the present disclosure.

FIG. 11 is a schematic diagram of the processing of a sensing service shown according to some embodiments of the present disclosure.

FIG. 12 is a schematic diagram of the processing of a sensing service shown according to some embodiments of the present disclosure.

FIG. 13 is a schematic diagram of an architecture of processing of a sensing service shown according to some embodiments of the present disclosure.

FIG. 14 is a schematic diagram of an architecture of processing of a sensing service shown according to some embodiments of the present disclosure.

FIG. 15 is a schematic flowchart of a method for determining a transmitter and/or a receiver for a sensing service shown according to some embodiments of the present disclosure.

FIG. 16 is a schematic flowchart of a method for determining a transmitter and/or a receiver for a sensing service shown according to some embodiments of the present disclosure.

FIG. 17 is a schematic flowchart of a method for determining a transmitter and/or a receiver for a sensing service shown according to some embodiments of the present disclosure.

FIG. 18 is a schematic flowchart of a method for determining a transmitter and/or a receiver for a sensing service shown according to some embodiments of the present disclosure.

FIG. 19 is a schematic structural diagram of an apparatus for determining a transmitter and/or a receiver for a sensing service shown according to some embodiments of the present disclosure.

FIG. 20 is a schematic structural diagram of a terminal shown according to some embodiments of the present disclosure.

FIG. 21 is a block diagram of a base station shown according to some embodiments of the present disclosure.

### DETAILED DESCRIPTION

Example embodiments will be described in detail here, examples of which are illustrated in the accompanying drawings. The following description refers to the accompanying drawings in which the same numbers in different drawings represent the same or similar elements unless otherwise represented. The implementations described in the following example embodiments do not represent all implementations consistent with the embodiments of the present disclosure. By contrast, they are merely examples of apparatuses and methods consistent with some aspects of the embodiments of the present disclosure as detailed in the appended claims.

The terms used in the embodiments of the present disclosure are merely for the purpose of describing particular embodiments, but not intended to limit the embodiments of the present disclosure. The singular forms “a” and “the” used in the embodiments of the present disclosure and the appended claims are also intended to include plural forms, unless the context clearly indicates other meanings. It should also be understood that the term “and/or” as used here refers to and includes any or all possible combinations of one or more associated listed items.

It should be understood that although the terms “first,” “second,” “third,” etc., may be used in the embodiments of the present disclosure to describe various information, these information should not be limited to these terms. These terms are only used to distinguish the same type of information from each other. For example, without departing from the scope of the embodiments of the present disclosure, the first information may also be referred to as second information, and similarly, the second information may also be referred to as first information. Depending on the context, the word “if” as used here may be interpreted as “at the time . . . ” or “when . . . ” or “in response to determining . . . ”.

For purposes of brevity and ease of understanding, the term of “greater than” or “less than” is used here to represent a size relationship. However, for those skilled in the art, it may be understood that the term “greater than” also covers a meaning of “greater than or equal to,” and “less than” also covers a meaning of “less than or equal to”.

Referring to FIG. 1, FIG. 1 is a schematic structural diagram of a wireless communication system shown according to some embodiments of the present disclosure. As shown in FIG. 1, the wireless communication system is a communication system based on a mobile communication technology, and the wireless communication system may include several user equipment 110 and several base stations 120.

Among them, the user equipment 110 may be a device that provides voice and/or data connectivity to a user. The user equipment 110 may communicate with one or more core network devices via a radio access network (RAN). The user equipment 110 may be an Internet of Things (IoT) terminal, such as a sensor device, a mobile phone, and a computer having an IoT terminal. For example, the user equipment 110 may be a fixed apparatus, a portable apparatus, a pocket-sized apparatus, a handheld apparatus, a computer-built-in apparatus, or a vehicle-mounted apparatus, such as a station (STA), a subscriber unit, a subscriber station, a mobile station, a mobile, a remote station, an access point, a remote terminal, an access terminal, a user terminal, a user agent, a user device, or user equipment (UE). Alternatively, the user equipment 110 may also be a device of an unmanned aerial vehicle. Alternatively, the user equipment 110 may also be a vehicle-mounted device, for example, may be a trip computer having a wireless communication function, or a wireless communication device externally connected to a trip computer. Alternatively, the user equipment 110 may also be an infrastructure, for example, may be a street lamp, a signal lamp, or another infrastructure having a wireless communication function, etc.

The base station 120 may be a network side device in the wireless communication system. Among them, the wireless communication system may be the 4th generation mobile communication (4G) system, which is also referred to as the long term evolution (LTE) system. Alternatively, the wireless communication system may also be the 5G system, which is also referred to as the new radio (NR) system, or the 5G NR system. Alternatively, the wireless communication system may be a next-generation system of the 5G system. Among them, the access network in the 5G system may be referred to as a new generation-radio access network (NG-RAN).

Among them, the base station 120 may be an evolved Node B (eNB) used in the 4G system. Alternatively, the base station 120 may also be a base station (gNB) adopting a centralized distributed architecture in the 5G system. When the base station 120 adopts a centralized distributed architecture, the base station 120 usually includes a central unit (CU) and at least two distributed units (DU). The centralized unit is provided with a protocol stack for a packet data convergence protocol (PDCP) layer, a radio link control (RLC) protocol layer, and a media access control (MAC) layer. The distributed unit is provided with a protocol stack for a physical (PHY) layer. The specific implementation of the base station 120 is not limited in the embodiments of the present disclosure.

A wireless connection may be established between the base station 120 and the user equipment 110 through a wireless air interface. In different embodiments, the wireless air interface is a wireless air interface based on the 4th generation mobile communication network technology (4G) standard. Alternatively, the wireless air interface is a wireless air interface based on the 5th generation mobile communication network technology (5G) standard, for example, the wireless air interface is a new radio. Alternatively, the wireless air interface may also be a wireless air interface based on a next-generation mobile communication network technology standard of 5G.

In some embodiments, an end to end (E2E) connection may also be established between the user equipment 110, for example, in the scenarios of a vehicle to vehicle (V2V) communication, a vehicle to infrastructure (V2I) communication, and a vehicle to pedestrian (V2P) communication in the vehicle to everything (V2X) communication.

Here, the user equipment may be considered as the terminal device in the following embodiments.

In some embodiments, the wireless communication system may further include a network management device 130.

Several base stations 120 are respectively connected to the network management device 130. Among them, the network management device 130 may be a core network device in the wireless communication system. For example, the network management device 130 may be a mobility management entity (MME) in an evolved packet core (EPC) network device. Alternatively, the network management device may be another core network device, such as a serving gateway (SGW), a public data network gateway (PGW), a policy and charging rules function (PCRF), or a home subscriber server (HSS), etc. The implementation form of the network management device 130 is not limited in the embodiments of the present disclosure.

In order to facilitate the understanding of those skilled in the art, in the embodiments of the present disclosure, a plurality of implementations are listed to clearly illustrate the technical solutions of the embodiments of the present disclosure. Certainly, those skilled in the art may understand that the plurality of embodiments provided in the embodiments of the present disclosure may be separately performed, or may be performed after being combined with the methods of other embodiments in the embodiments of the present disclosure, or may be performed separately or in combination with some methods in other related technologies, which is not limited in the embodiments of the present disclosure.

In order to better understand the technical solutions described in any one of the embodiments of the present disclosure, firstly, an application scenario in the related art is described.

In some embodiments, the wireless sensing technology is intended to obtain information about a target object and environment features of the target object by using the wireless communication technology (for example, E-UTRA, 5G NR, WiFi, Bluetooth, etc.), where the information about the target object and the environmental features of the target object include features such as shape, size, speed, position, distance, or relative motion between objects. Radar (radio detection and ranging) is a widely used wireless sensing technology that utilizes radio waves to determine the distance (range), angle, or instantaneous linear velocity of an object. There are still other sensing technologies, including non-radio frequency (RF) sensors, which have been used in other fields such as time-of-flight cameras, accelerometers, gyroscopes, and laser radar.

Integrated sensing and communication in the 5th generation mobile communication technology (5G) means that the sensing capability is provided by the new radio communication system and infrastructure used for communication, and the sensing information may be derived from RF-based and/or non-RF based sensors. It may also be referred to as an integrated sensing and communication service. In general, it may involve a scenario of communication assisted sensing, e.g., a scenario where the 5G communication system provides a sensing service or sensing assisted communication. For example, the sensing information related to the communication channel or environment is used to improve the communication service of the 5G system itself. For example, the sensing information may be used to assist radio resource management, interference mitigation, beam management, mobility, etc.

In a plurality of market segments and verticals, the 5G-based sensing service may be beneficial for intelligent transportation, aviation, enterprise, smart city, smart home, factories, consumer applications, and public sector.

The mobile operator may play an important role in providing a 5G system-based integrated sensing and communication to the customer, including the management and control of 5G-based sensing service. The related technologies illustrate the roles that the operator may play to enhance V2X type of services, specifically for Infrastructure Assisted Environment Perception, Infrastructure-Based Tele-Operated Driving, High-Definition Map Collecting and Sharing and Tele-Operated Driving Support.

In some embodiments, examples in which the 5G system provides a communication assisted sensing service may include the following.

Environment real-time monitoring. The environment map is reconstructed by using wireless signals to further improve positioning accuracy and enable environment related applications, such as realizing an array of real-time monitoring related applications including dynamic 3D map for driving assistance, pedestrian flow statistics, intrusion detection, traffic detection and etc.

Autonomous vehicles or unmanned aerial vehicles (UAV). Autonomous vehicles or UAV applications have some common functional requirements. For example, autonomous vehicles or UAV shall support Detect and Avoid (DAA) to avoid obstacles. Meanwhile, autonomous vehicles or UAV shall have the capability to monitor path information, such as selecting routes, complying with traffic regulations.

Air pollution monitoring. The quality of the received wireless signal displays different attenuation characteristics with changes in air humidity, air particulate matter (PM) concentration, carrier frequency and etc., which may be used for weather or air quality detection.

Indoor health care and intrusion detection. Respiration rate estimation, breathing depth estimation, apnea detection, elders' vital sign monitoring and indoor intrusion detection can be realized.

In some embodiments, the sensing of wireless communication channels and environment may further improve the performance of the communication system. Some examples of the sensing assisted communication scenario include:
sensing UE's location and channel environment to narrow the beam sweeping range and shorten the beam training time;
sensing UE's location, velocity, motion trajectory, and channel environment for beam prediction, and reducing the overhead of beam measurement and the delay of beam tracking;
sensing UE's property and channel environment to improve the performance of channel estimation.

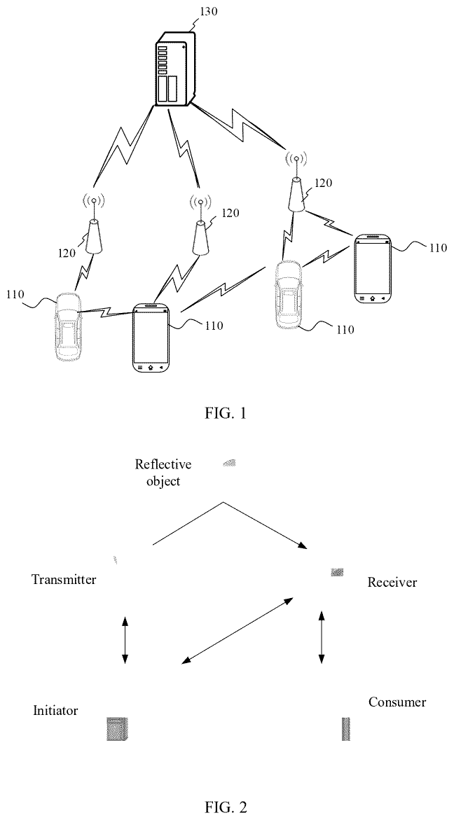

In some embodiments, referring to FIG. 2, there are different roles in a sensing system.

Reflective object: a target object whose information is sensed.

Transmitter: a device that transmits a radio signal to a target object. It may be a terminal or a base station.

Receiver: a device that detects sensing information according to a reflective signal of a radio signal from a target object. It may be a terminal or a base station.

Initiator: an authorized device that requests from or subscribes to one or more receivers for the sensing information. It may be a terminal, a base station, or a network function. It is usually the device that collects the sensing information and processes it to generate the sensing result.

Consumer: it consumes the output calculated from the sensing information. For example, it may be a terminal application, or may be a sensing application server.

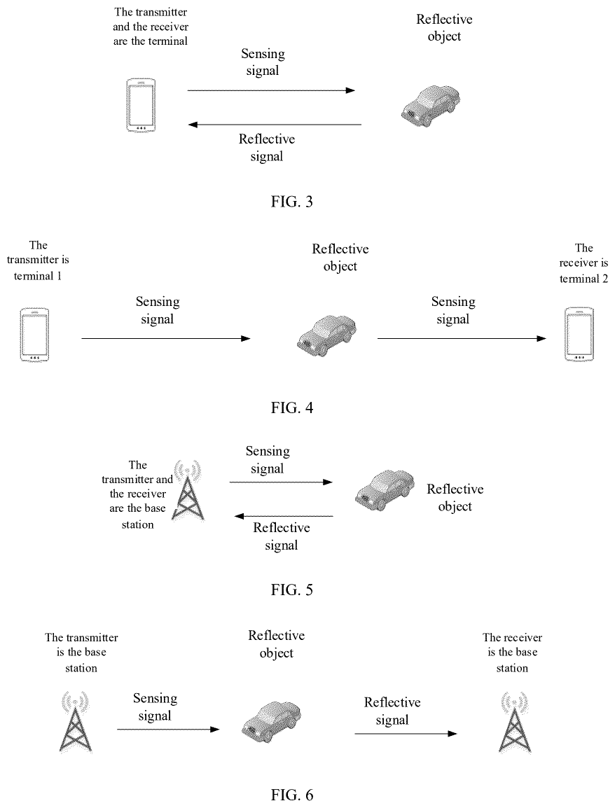

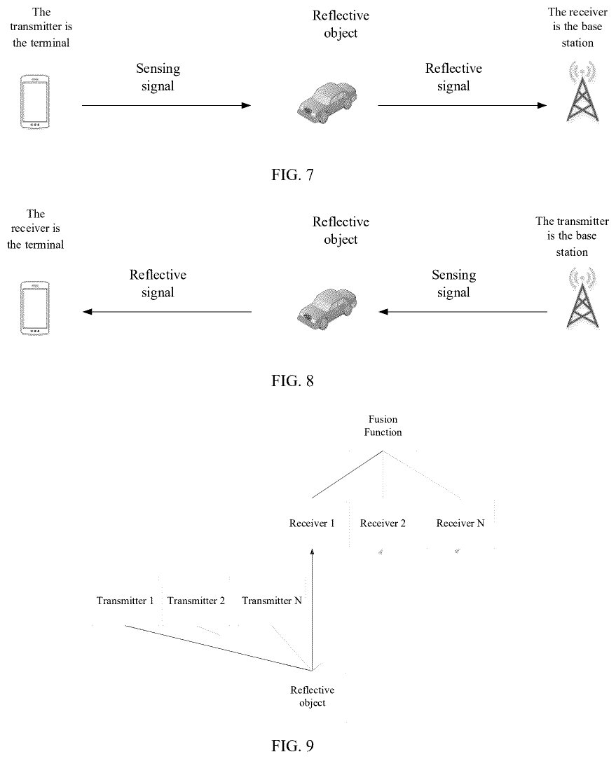

It should be noted that the transmitter, the receiver, the initiator, and the consumer may be paired or all collocated. Referring to FIG. 3 to FIG. 8, in terms of whether the terminal or the base station may perform as a transmitter or a receiver in an integrated sensing and communication service or not, and there are six combinations.

It should be noted that the sensing modes involved in the present disclosure may include: a mode in which a terminal transmits and a terminal receives, a mode in which a base station transmits and a base station receives, or a mode in which a terminal and a base station transmit and receive in hybrid.

The sensing fusion is the process of combining the sensing data from different sources to derive the sensing results, such that the uncertainty of the sensing results is lower than the uncertainty that may occur when these sources are used alone. The sensing fusion may also be understood as sense fusion, perception fusion, etc., which is not limited here.

Referring to FIG. 9, FIG. 9 is an overall fusion architecture in which the fusion function collects the sensing information from a plurality of receivers.

The fusion function may be in a terminal, a base station, a network function, or an application server. According to which entity performs the fusion function, there may be four fusion modes as follows.

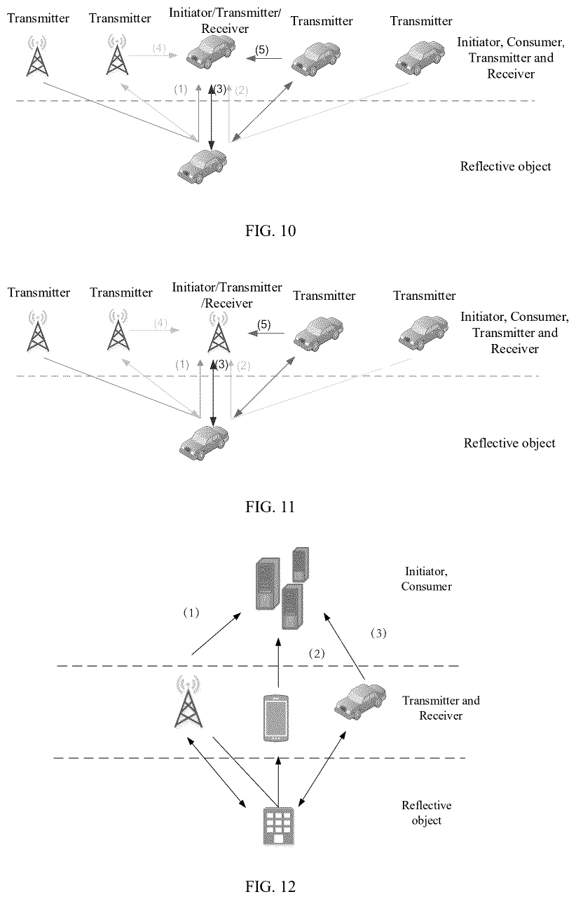

Terminal-based fusion: the terminal performs the fusion function, and reference may be made to FIG. 10 for details.

Base station-based fusion: the base station performs the fusion function, and reference may be made to FIG. 11 for details.

Fusion Network function-based fusion: the network function performs the fusion function, reference may be made to FIG. 12 for details.

Application-based fusion: the application server performs the fusion function, reference may be made to FIG. 12 for details.

In some embodiments, to support the integrated sensing and communication in a network core network, it needs to consider the following aspects:
1. controlling the sensing by using an operator of the licensed frequency;
2. network assistance and coordination for performing the sensing;
3. determination of the sensing mode;
4. discovering and selecting a transmitter and a receiver;
5. service capability opening or service triggering; and
6. data collection during aggregation and processing of the sensing information on the network side (for example, when fusion is required);
where, aspects of 1 to 5 are implemented by a control plane function, and the aspect of 6 may be implemented on a control plane or a user plane.

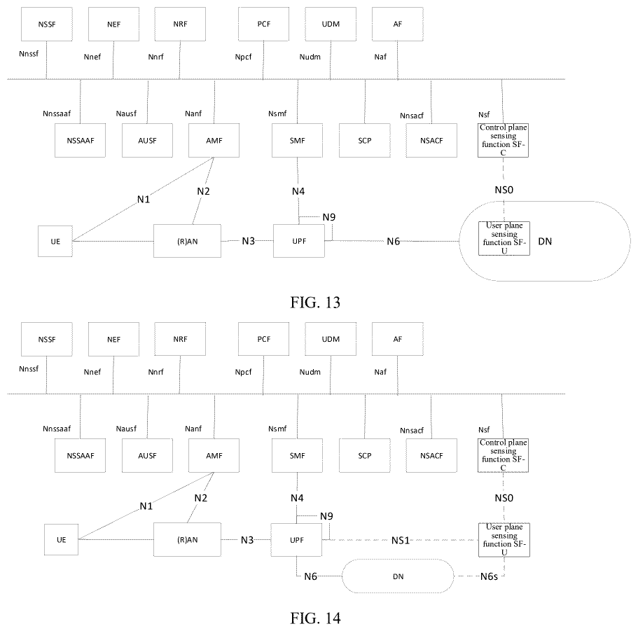

In some embodiments, the control plane sensing function SF-C and the user plane sensing function SF-U are introduced into the core network to support integrated sensing and communication. SF-C is a control plane network function, and is responsible for processing control plane signaling. SF-U is a user plane entity, and is responsible for data collection, aggregation and processing under the control of SF-C. Referring to FIG. 13, the SF-U may be an application server in the data network DN. Referring to FIG. 14, SF-U may also be a core network element.

In some embodiments, NS0 is an interface between SF-C and SF-U, and is configured to control data collection, aggregation, and processing. SF-C and SF-U may be collocated, in which case NS0 is an internal interface. NS1 is an interface between UPF and SF-U, and is configured to transmit sensing information between UPF and SF-U. Nos is configured for interaction between SF-U and the sensing application in DN.

In some embodiments, SF-U is only applicable to the cases that network-based sensing is used. When SF-U is not applicable, NS0 is also not applicable.

In some embodiments, when determining the network-based sensing and determining that the data collection is on the user plane, SF-C needs to perform:
1. SF-U selection; and
2. Establishment of a PDU session between the gNB and SF-U.

In some embodiments, SF-C is responsible for determining, according to the terminal, the base station or the network capability and the sensing application requirements (e.g. quality of service QoS, including delay and accuracy), the sensing information processing mode (i.e., terminal-based sensing, base station-based sensing, or network-based sensing).

In some embodiments, SF-C is responsible for determining, according to the terminal, the base station or the network capability and the sensing application requirements (e.g., QoS, including delay and accuracy), whether to use the control plane or the user-oriented network for transmission of the sensing information.

In some embodiments, determination of the sensing mode and selection of the transmitter and the receiver may be performed by considering the following standards:
Service authorization of a terminal or a base station: whether to authorize the terminal or the base station as a transmitter or a receiver to perform a service;
Capability of a terminal or a base station: whether the terminal or the base station can work in a specific sensing mode, or whether the terminal or the base station can perform as a transmitter or a receiver;
Expected candidate transmitter or receiver;
User consent: a willingness of selecting a terminal as a transmitter or a receiver;
Service type: for a specific service, only a terminal, or only a base station, or both
of the terminal and the base station may perform as a transmitter or a receiver;
Service QoS requirements: one or more transmitters or receivers have to be selected. For example, when QoS requirements are high, more than one transmitter or receiver may be selected; and
Availability of a terminal or a base station: a terminal or a base station that can perform sensing and detection in a specific area.

If both the terminal and the base station are selected, there may be no service relationship between the selected terminal and the selected base station, that is, the base station is not the serving base station of the terminal, which may complicate the service triggering and interaction process between the terminal and the base station.

In order to trigger the sensing procedure, the service request has to arrive at the selected base station and the selected terminal through different non-synchronization paths. Communication between the selected terminal and the selected base station for transmission of control signaling and/or sensing data (e.g., if it is detected at the base station that sensing data is sent to the terminal for analysis) is indirect. In order to support the hybrid sensing mode in the sensing service, during performing of the sensing service, it is needed to select a terminal and/or a base station as a receiver and/or a transmitter. How to select the terminal and/or the base station as the receiver and/or the transmitter is a problem that needs to be considered, especially when both the terminal and the base station are included during selection of the receiver and/or the transmitter. In view of this, Embodiments of the present disclosure disclose a method and apparatus for determining a transmitter and/or a receiver for a sensing service, a communication device, and a storage medium.

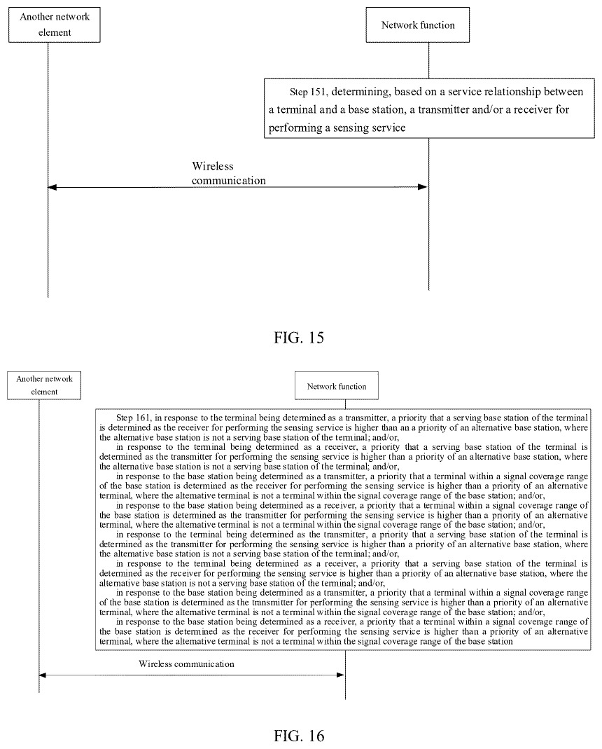

As shown in FIG. 15, the present embodiment provides a method for determining a transmitter and/or a receiver for a sensing service, where the method is performed by a network function, and the method includes the following step.

In step 151, a transmitter and/or a receiver for performing a sensing service is determined based on a service relationship between the terminal and the base station.

Here, the terminal involved in the present disclosure may be, but is not limited to, a mobile phone, a wearable device, a vehicle-mounted terminal, a road side unit (RSU), a smart home terminal, an industrial sensing device, and/or a medical device. In some embodiments, the terminal may be a Redcap terminal or a predetermined version of a new radio (NR) terminal (for example, an NR terminal of R17).

The base station involved in the present disclosure may be various types of base stations, for example, a base station in a 3th generation mobile communication (3G) network, a base station in a 4th generation mobile communication (4G) network, a base station in a 5th generation mobile communication (5G) network, or other evolved base stations.

The network element involved in the present disclosure may be an access control and mobility management function (AMF), a control plane sensing function (SF-C), a unified data management (UDM), and a sensing APP, etc. It should be noted that, the network element is not limited to the foregoing example, and may be any network element having a sensing function (SF). In some implementations of the present disclosure, the network element with an SF may be separately deployed as a communication node, or may be uniformly deployed in an existing network element. In conclusion, the network element with an SF may be understood as a logical node that may be flexibly deployed in a network, which is not limited here.

In some embodiments, a service relationship between the terminal and the base station is determined; and based on the service relationship between the terminal and the base station, a transmitter and/or a receiver for performing the sensing service are determined. It should be noted that, the service relationship between the terminal and the base station may be determined based on a relationship that the base station provides a service for the terminal, or determined based on a relationship between a base station accessed by the terminal and the base station, or determined based on a relationship between a location of the terminal and a signal coverage range of the base station.

In some embodiments, the service relationship includes at least one of the following:
the base station being a serving base station of the terminal;
the base station being not a serving base station of the terminal;
the terminal being within a signal coverage range of the base station; or
the terminal being not within a signal coverage range of the base station.

In some embodiments, in response to the terminal being a transmitter and the base station being a serving base station of the terminal, it is determined that the receiver for performing the sensing service is the base station. It should be noted that the transmitter is a device that transmits a radio signal to a target object when performing the sensing service. The receiver is a device that detects the sensing information according to a reflective signal of the radio signal from the target object when performing the sensing service.

In some embodiments, in response to the base station being a transmitter and the base station being a serving base station of the terminal, it is determined that the receiver for performing the sensing service is the terminal. It should be noted that the transmitter is a device that transmits a radio signal to a target object when performing the sensing service. The receiver is a device that detects the sensing information according to a reflective signal of the radio signal from the target object when performing the sensing service.

In some embodiments, in response to the terminal being a transmitter and the terminal being within the signal coverage range of the base station, it is determined that the receiver for performing the sensing service is the base station. It should be noted that the transmitter is a device that transmits a radio signal to a target object when performing the sensing service. The receiver is a device that detects the sensing information according to a reflective signal of the radio signal from the target object when performing the sensing service.

In some embodiments, in response to the base station being a transmitter and the terminal being within the signal coverage range of the base station, it is determined that the receiver for performing the sensing service is the terminal. It should be noted that the transmitter is a device that transmits a radio signal to a target object when performing the sensing service. The receiver is a device that detects the sensing information according to a reflective signal of the radio signal from the target object when performing the sensing service.

In some embodiments, based on a service relationship between a terminal and a base station, a transmitter and/or a receiver for performing a sensing service are determined, where in response to the terminal being a transmitter, the receiver is the base station. Alternatively, based on a service relationship between a terminal and a base station, a transmitter and/or a receiver for performing a sensing service are determined, where in response to the base station being a transmitter, the receiver is the terminal. Alternatively, based on a service relationship between a terminal and a base station, a transmitter and/or a receiver for performing a sensing service are determined, where both the base station and the terminal are transmitters. Alternatively, based on a service relationship between a terminal and a base station, a transmitter and/or a receiver for performing a sensing service are determined, where both the base station and the terminal are receivers.

In some embodiments, based on a service relationship between the terminal and the base station, a transmitter and/or a receiver for performing the sensing service are determined. In response to the terminal being determined as the transmitter, a priority that a serving base station of the terminal is determined as the receiver for performing the sensing service is higher than a priority of an alternative base station, where the alternative base station is not a serving base station of the terminal.

In some embodiments, based on a service relationship between the terminal and the base station, a transmitter and/or a receiver for performing the sensing service are determined. In response to the terminal being determined as the receiver, a priority that a serving base station of the terminal is determined as the transmitter for performing the sensing service is higher than a priority of an alternative base station, where the alternative base station is not a serving base station of the terminal.

In some embodiments, based on a service relationship between the terminal and the base station, a transmitter and/or a receiver for performing the sensing service are determined. In response to the base station being determined as the transmitter, a priority that a terminal within a signal coverage range of the base station is determined as the receiver for performing the sensing service is higher than a priority of an alternative terminal, where the alternative terminal is not a terminal within the signal coverage range of the base station.

In some embodiments, based on a service relationship between the terminal and the base station, a transmitter and/or a receiver for performing the sensing service are determined. In response to the base station being determined as the receiver, a priority that a terminal within a signal coverage range of the base station is determined as the transmitter for performing the sensing service is higher than a priority of an alternative terminal, where the alternative terminal is not a terminal within the signal coverage range of the base station.

In some embodiments, based on a service relationship between the terminal and the base station, a transmitter and/or a receiver for performing the sensing service are determined. In response to the terminal being determined as the transmitter, a priority that a serving base station of the terminal is determined as the transmitter for performing the sensing service is higher than a priority of an alternative base station, where the alternative base station is not a serving base station of the terminal.

In some embodiments, based on a service relationship between the terminal and the base station, a transmitter and/or a receiver for performing the sensing service are determined. In response to the terminal being determined as the receiver, a priority that a serving base station of the terminal is determined as the receiver for performing the sensing service is higher than a priority of an alternative base station, where the alternative base station is not a serving base station of the terminal.

In some embodiments, based on a service relationship between the terminal and the base station, a transmitter and/or a receiver for performing the sensing service are determined. In response to the base station being determined as the transmitter, a priority that a terminal within a signal coverage range of the base station is determined as the transmitter for performing the sensing service is higher than a priority of an alternative terminal, where the alternative terminal is not a terminal within the signal coverage range of the base station.

In some embodiments, based on a service relationship between the terminal and the base station, a transmitter and/or a receiver for performing the sensing service are determined. In response to the base station being determined as the receiver, a priority that a terminal within a signal coverage range of the base station is determined as the receiver for performing the sensing service is higher than a priority of an alternative terminal, where the alternative terminal is not a terminal within the signal coverage range of the base station.

In some embodiments, based on a service relationship between the terminal and the base station, a transmitter and/or a receiver for performing the sensing service are determined. In response to the base station being a serving base station of the terminal and the terminal being determined as the receiver, it is determined that the base station is the transmitter.

In some embodiments, based on a service relationship between the terminal and the base station, a transmitter and/or a receiver for performing the sensing service are determined. In response to the base station being a serving base station of the terminal and the terminal being determined as the transmitter, it is determined that the base station is the receiver.

In some embodiments, based on a service relationship between the terminal and the base station, a transmitter and/or a receiver for performing the sensing service are determined. In response to the base station being a serving base station of the terminal and the base station being determined as the receiver, it is determined that the terminal is the transmitter.

In some embodiments, based on a service relationship between the terminal and the base station, a transmitter and/or a receiver for performing the sensing service are determined. In response to the base station being a serving base station of the terminal and the base station being determined as the transmitter, it is determined that the terminal is the receiver.

In some embodiments, based on a service relationship between the terminal and the base station, a transmitter and/or a receiver for performing the sensing service are determined. In response to the base station being a serving base station of the terminal and the terminal being determined as the receiver, it is determined that the base station is the receiver.

In some embodiments, based on a service relationship between the terminal and the base station, a transmitter and/or a receiver for performing the sensing service are determined. In response to the base station being a serving base station of the terminal and the terminal being determined as the transmitter, it is determined that the base station is the transmitter.

In some embodiments, based on a service relationship between the terminal and the base station, a transmitter and/or a receiver for performing the sensing service are determined. In response to the base station being a serving base station of the terminal and the base station being determined as the receiver, it is determined that the terminal is the receiver.

In some embodiments, based on a service relationship between the terminal and the base station, a transmitter and/or a receiver for performing the sensing service are determined. In response to the base station being a serving base station of the terminal and the base station being determined as the transmitter, it is determined that the terminal is the transmitter.

In some embodiments, based on a service relationship between the terminal and the base station, a transmitter and/or a receiver for performing the sensing service are determined. In response to determining the receiver and the transmitter, the sensing service is triggered.

In some embodiments, based on a service relationship between the terminal and the base station, a transmitter and/or a receiver for performing the sensing service are determined. In response to determining the receiver and the transmitter, sensing service request information is sent to the base station through an N2 message, where the sensing service request information is used to be sent by the base station to the terminal through a radio resource control (RRC) message.

In some embodiments, based on a service relationship between the terminal and the base station, a transmitter and/or a receiver for performing the sensing service are determined. In response to determining the receiver and the transmitter, sensing service request information is sent to the base station through an N2 message, and sensing service request information is sent to the UE terminal through an N1 message.

In the embodiments of the present disclosure, based on the service relationship between the terminal and the base station, the transmitter and/or the receiver for performing the sensing service are determined. Here, since the transmitter and/or the receiver for performing the sensing service are determined based on the service relationship between the terminal and the base station, the transmitter and/or the receiver for performing the sensing service may adapt to the service relationship between the terminal and the base station. Compared with a manner of randomly selecting the terminal or the base station as a transmitter and/or a receiver, the synchronization of the service triggering and the efficient interaction between the terminal and the base station may be ensured.

It should be noted that those skilled in the art may understand that the method provided in the embodiments of the present disclosure may be performed separately, or may be performed with some methods in the embodiments of the present disclosure or some methods in the related art.

As shown in FIG. 16, the present embodiment provides a method for determining a transmitter and/or a receiver for a sensing service, where the method is performed by a network function, and the method includes the following step.

In step 161, in response to the terminal being determined as a transmitter, a priority that a serving base station of the terminal is determined as the receiver for performing the sensing service is higher than a priority of an alternative base station, where the alternative base station is not a serving base station of the terminal; and/or, in response to the terminal being determined as a receiver, a priority that a serving base station of the terminal is determined as the transmitter for performing the sensing service is higher than a priority of an alternative base station, where the alternative base station is not a serving base station of the terminal; and/or, in response to the base station being determined as a transmitter, a priority that a terminal within a signal coverage range of the base station is determined as the receiver for performing the sensing service is higher than a priority of an alternative terminal, where the alternative terminal is not a terminal within the signal coverage range of the base station; and/or, in response to the base station being determined as a receiver, a priority that a terminal within a signal coverage range of the base station is determined as the transmitter for performing the sensing service is higher than a priority of an alternative terminal, where the alternative terminal is not a terminal within the signal coverage range of the base station; and/or, in response to the terminal being determined as the transmitter, a priority that a serving base station of the terminal is determined as the transmitter for performing the sensing service is higher than a priority of an alternative base station, where the alternative base station is not a serving base station of the terminal; and/or, in response to the terminal being determined as a receiver, a priority that a serving base station of the terminal is determined as the receiver for performing the sensing service is higher than a priority of an alternative base station, where the alternative base station is not a serving base station of the terminal; and/or, in response to the base station being determined as a transmitter, a priority that a terminal within a signal coverage range of the base station is determined as the transmitter for performing the sensing service is higher than a priority of an alternative terminal, where the alternative terminal is not a terminal within the signal coverage range of the base station; and/or, in response to the base station being determined as a receiver, a priority that a terminal within a signal coverage range of the base station is determined as the receiver for performing the sensing service is higher than a priority of an alternative terminal, where the alternative terminal is not a terminal within the signal coverage range of the base station.

It should be noted that, the priority that a serving base station of the terminal is determined as the receiver for performing the sensing service is higher than a priority of an alternative base station, that is, the serving base station of the terminal may be determined as the receiver preferentially to the alternative base station.

It should be noted that, a priority that a serving base station of the terminal is determined as the transmitter for performing the sensing service is higher than a priority of an alternative base station, that is, the serving base station of the terminal may be determined as the transmitter preferentially to the alternative base station.

It should be noted that, a priority that a terminal within a signal coverage range of the base station is determined as the receiver for performing the sensing service is higher than a priority of an alternative terminal, that is, a terminal within a signal coverage range of the base station may be determined as the receiver preferentially to the alternative terminal.

It should be noted that, a priority that a terminal within a signal coverage range of the base station is determined as the transmitter for performing the sensing service is higher than a priority of an alternative terminal, that is, a terminal within a signal coverage range of the base station may be determined as the transmitter preferentially to the alternative terminal.

In some embodiments, based on a service relationship between the terminal and the base station, a transmitter and/or a receiver for performing the sensing service are determined. In response to the terminal being determined as the transmitter, a priority that a serving base station of the terminal is determined as the receiver for performing the sensing service is higher than a priority of an alternative base station, where the alternative base station is not a serving base station of the terminal.

In some embodiments, based on a service relationship between the terminal and the base station, a transmitter and/or a receiver for performing the sensing service are determined. In response to the terminal being determined as the receiver, a priority that a serving base station of the terminal is determined as the transmitter for performing the sensing service is higher than a priority of an alternative base station, where the alternative base station is not a serving base station of the terminal.

In some embodiments, based on a service relationship between the terminal and the base station, a transmitter and/or a receiver for performing the sensing service are determined. In response to the base station being determined as the transmitter, a priority that a terminal within a signal coverage range of the base station is determined as the receiver for performing the sensing service is higher than a priority of an alternative terminal, where the alternative terminal is not a terminal within the signal coverage range of the base station.

In some embodiments, based on a service relationship between the terminal and the base station, a transmitter and/or a receiver for performing the sensing service are determined. In response to the base station being determined as the receiver, a priority that a terminal within a signal coverage range of the base station is determined as the transmitter for performing the sensing service is higher than a priority of an alternative terminal, where the alternative terminal is not a terminal within the signal coverage range of the base station.

In some embodiments, based on a service relationship between the terminal and the base station, a transmitter and/or a receiver for performing the sensing service are determined. In response to the terminal being determined as the transmitter, a priority that a serving base station of the terminal is determined as the transmitter for performing the sensing service is higher than a priority of an alternative base station, where the alternative base station is not a serving base station of the terminal.

In some embodiments, based on a service relationship between the terminal and the base station, a transmitter and/or a receiver for performing the sensing service are determined. In response to the terminal being determined as the receiver, a priority that a serving base station of the terminal is determined as the receiver for performing the sensing service is higher than a priority of an alternative base station, where the alternative base station is not a serving base station of the terminal.

In some embodiments, based on a service relationship between the terminal and the base station, a transmitter and/or a receiver for performing the sensing service are determined. In response to the base station being determined as the transmitter, a priority that a terminal within a signal coverage range of the base station is determined as the transmitter for performing the sensing service is higher than a priority of an alternative terminal, where the alternative terminal is not a terminal within the signal coverage range of the base station.

In some embodiments, based on a service relationship between the terminal and the base station, a transmitter and/or a receiver for performing the sensing service are determined. In response to the base station being determined as the receiver, a priority that a terminal within a signal coverage range of the base station is determined as the receiver for performing the sensing service is higher than a priority of an alternative terminal, where the alternative terminal is not a terminal within the signal coverage range of the base station.

It should be noted that those skilled in the art may understand that the method provided in the embodiments of the present disclosure may be performed separately, or may be performed with some methods in the embodiments of the present disclosure or some methods in the related art.

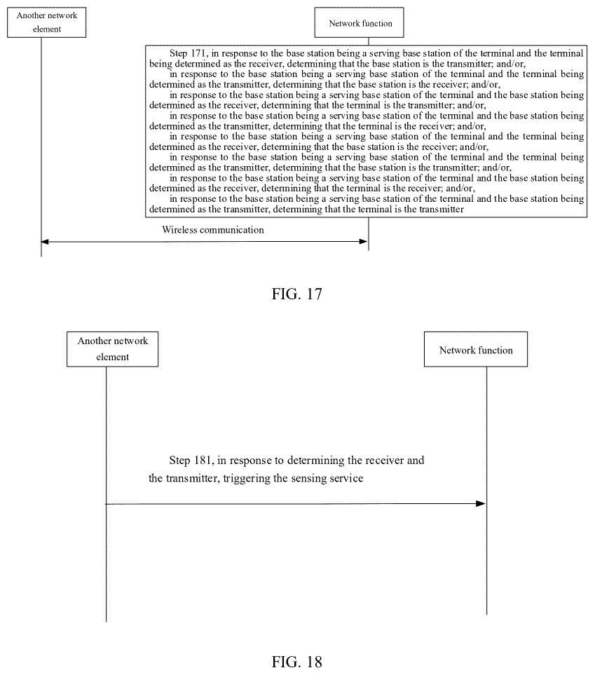

As shown in FIG. 17, the present embodiment provides a method for determining a transmitter and/or a receiver for a sensing service, where the method is performed by a network function, and the method includes the following step.

In step 171, in response to the base station being a serving base station of the terminal and the terminal being determined as the receiver, it is determined that the base station is the transmitter; and/or, in response to the base station being a serving base station of the terminal and the terminal being determined as the transmitter, it is determined that the base station is the receiver; and/or, in response to the base station being a serving base station of the terminal and the base station being determined as the receiver, it is determined that the terminal is the transmitter; and/or, in response to the base station being a serving base station of the terminal and the base station being determined as the transmitter, it is determined that the terminal is the receiver; and/or, in response to the base station being a serving base station of the terminal and the terminal being determined as the receiver, it is determined that the base station is the receiver; and/or, in response to the base station being a serving base station of the terminal and the terminal is determined as the transmitter, it is determined that the base station is the transmitter; and/or, in response to the base station being a serving base station of the terminal and the base station being determined as the receiver, it is determined that the terminal is the receiver; and/or, in response to the base station being a serving base station of the terminal and the base station being determined as the transmitter, it is determined that the terminal is the transmitter.

In some embodiments, based on a service relationship between the terminal and the base station, a transmitter and/or a receiver for performing the sensing service are determined. In response to the base station being a serving base station of the terminal and the terminal is determined as the receiver, it is determined that the base station is the transmitter.

In some embodiments, based on a service relationship between the terminal and the base station, a transmitter and/or a receiver for performing the sensing service are determined. In response to the base station being a serving base station of the terminal and the terminal is determined as the transmitter, it is determined that the base station is the receiver.

In some embodiments, based on a service relationship between the terminal and the base station, a transmitter and/or a receiver for performing the sensing service are determined. In response to the base station being a serving base station of the terminal and the base station is determined as the receiver, it is determined that the terminal is the transmitter.

In some embodiments, based on a service relationship between the terminal and the base station, a transmitter and/or a receiver for performing the sensing service are determined. In response to the base station being a serving base station of the terminal and the base station is determined as the transmitter, it is determined that the terminal is the receiver.

In some embodiments, based on a service relationship between the terminal and the base station, a transmitter and/or a receiver for performing the sensing service are determined. In response to the base station being a serving base station of the terminal and the terminal is determined as the receiver, it is determined that the base station is the receiver.

In some embodiments, based on a service relationship between the terminal and the base station, a transmitter and/or a receiver for performing the sensing service are determined. In response to the base station being a serving base station of the terminal and the terminal is determined as the transmitter, it is determined that the base station is the transmitter.

In some embodiments, based on a service relationship between the terminal and the base station, a transmitter and/or a receiver for performing the sensing service are determined. In response to the base station being a serving base station of the terminal and the base station is determined as the receiver, it is determined that the terminal is the receiver.

In some embodiments, based on a service relationship between the terminal and the base station, a transmitter and/or a receiver for performing the sensing service are determined. In response to the base station being a serving base station of the terminal and the base station is determined as the transmitter, it is determined that the terminal is the transmitter.

It should be noted that those skilled in the art may understand that the method provided in the embodiments of the present disclosure may be performed separately, or may be performed with some methods in the embodiments of the present disclosure or some methods in the related art.

As shown in FIG. 18, the present embodiment provides a method for determining a transmitter and/or a receiver for a sensing service, where the method is performed by a network function, and the method includes the following step.

Step 181, in response to determining the receiver and the transmitter, the sensing service is triggered.

In some embodiments, based on a service relationship between the terminal and the base station, a transmitter and/or a receiver for performing the sensing service are determined. In response to determining the receiver and the transmitter, the sensing service is triggered.

In some embodiments, based on a service relationship between the terminal and the base station, a transmitter and/or a receiver for performing the sensing service are determined. In response to determining the receiver and the transmitter, sensing service request information is sent to the base station through an N2 message, where the sensing service request information is used to be sent by the base station to the terminal through a radio resource control (RRC) message.

In some embodiments, based on a service relationship between the terminal and the base station, a transmitter and/or a receiver for performing the sensing service are determined. In response to determining the receiver and the transmitter, the sensing service request information is sent to the base station through an N2 message, and the sensing service request information is sent to the UE terminal through an N1 message.

It should be noted that those skilled in the art may understand that the method provided in the embodiments of the present disclosure may be performed separately, or may be performed with some methods in the embodiments of the present disclosure or some methods in the related art.

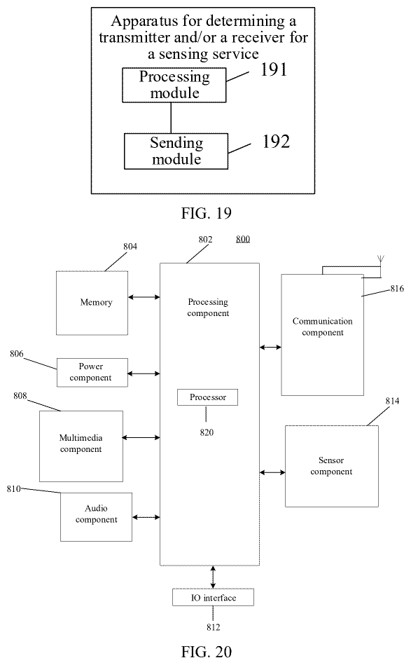

As shown in FIG. 19, in the present embodiment, there is provided an apparatus for determining a transmitter and/or a receiver for a sensing service, where the apparatus includes a processing module 191.

The processing module 191 is configured to determine, based on a service relationship between a terminal and a base station, a transmitter and/or a receiver for performing a sensing service.

In some embodiments, the service relationship includes at least one of the following:
the base station being a serving base station of the terminal;
the base station being not a serving base station of the terminal;
the terminal being within a signal coverage range of the base station; or
the terminal being not within a signal coverage range of the base station.

In some embodiments, in response to the terminal being a transmitter, the receiver is the base station; or, in response to the base station being a transmitter, the receiver is the terminal; or, both the base station and the terminal are transmitters; or, both the base station and the terminal are receivers.

In some embodiments, in response to the terminal being determined as the transmitter, a priority that a serving base station of the terminal is determined as the receiver for performing the sensing service is higher than a priority of an alternative base station, where the alternative base station is not a serving base station of the terminal;
and/or,
in response to the terminal being determined as the receiver, a priority that a serving base station of the terminal is determined as the transmitter for performing the sensing service is higher than a priority of an alternative base station, where the alternative base station is not a serving base station of the terminal;
and/or,
in response to the base station being determined as the transmitter, a priority that a terminal within a signal coverage range of the base station is determined as the receiver for performing the sensing service is higher than a priority of an alternative terminal, where the alternative terminal is not a terminal within the signal coverage range of the base station;
and/or,
in response to the base station being determined as the receiver, a priority that a terminal within a signal coverage range of the base station is determined as the transmitter for performing the sensing service is higher than a priority of an alternative terminal, where the alternative terminal is not a terminal within the signal coverage range of the base station;
and/or,
in response to the terminal being determined as the transmitter, a priority that a serving base station of the terminal is determined as the transmitter for performing the sensing service is higher than a priority of an alternative base station, where the alternative base station is not a serving base station of the terminal;
and/or,
in response to the terminal being determined as the receiver, a priority that a serving base station of the terminal is determined as the receiver for performing the sensing service is higher than a priority of an alternative base station, where the alternative base station is not a serving base station of the terminal;
and/or,
in response to the base station being determined as the transmitter, a priority that a terminal within a signal coverage range of the base station is determined as the transmitter for performing the sensing service is higher than a priority of an alternative terminal, where the alternative terminal is not a terminal within the signal coverage range of the base station;
and/or,
in response to the base station being determined as the receiver, a priority that a terminal within a signal coverage range of the base station is determined as the receiver for performing the sensing service is higher than a priority of an alternative terminal, where the alternative terminal is not a terminal within the signal coverage range of the base station.

In some embodiments, the processing module 191 is further configured to:
in response to the base station being a serving base station of the terminal and the terminal being determined as the receiver, determine that the base station is the transmitter;
and/or,
in response to the base station being a serving base station of the terminal and the terminal being determined as the transmitter, determine that the base station is the receiver;
and/or,
in response to the base station being a serving base station of the terminal and the base station being determined as the receiver, determine that the terminal is the transmitter;
and/or,
in response to the base station being a serving base station of the terminal and the base station being determined as the transmitter, determine that the terminal is the receiver;
and/or,
in response to the base station being a serving base station of the terminal and the terminal being determined as the receiver, determine that the base station is the receiver;
and/or,
in response to the base station being a serving base station of the terminal and the terminal being determined as the transmitter, determine that the base station is the transmitter; and
and/or,
in response to the base station being a serving base station of the terminal and the base station being determined as the receiver, determine that the terminal is the receiver;
and/or,
in response to the base station being a serving base station of the terminal and the base station being determined as the transmitter, determine that the terminal is the transmitter.

In some embodiments, the processing module 191 is further configured to:
in response to determining the receiver and the transmitter, trigger the sensing service.

In some embodiments, the apparatus further includes a sending module 192.

The sending module 192 is configured to:
send sensing service request information to the base station through an N2 message, where the sensing service request information is used to be sent by the base station to the terminal through a radio resource control (RRC) message;
or,
send the sensing service request information to the base station through an N2 message, and send the sensing service request information to the terminal through an N1 message.

It should be noted that those skilled in the art may understand that the method provided in the embodiments of the present disclosure may be performed separately, or may be performed with some methods in the embodiments of the present disclosure or some methods in the related art.

In order to better understand the embodiments of the present disclosure, the technical solutions of the present disclosure are further described below by using an example embodiment.

### Example 1

In order to support hybrid sensing modes in integrated sensing and communication services, that is, the terminal serves as a transmitter and the base station serves as a receiver, or the base station serves as a transmitter and the terminal serves as a receiver, a service relationship between the terminal and the base station needs relationships other than other standards. For other standards, reference may be made to the description in the foregoing application scenario description.

When one or more terminals are selected as transmitters or receivers for the first time, if the same other standards are satisfied, the serving base stations of the one or more terminals have a higher priority of being selected as the opposite end than any other base station.

When one or more base stations are selected as transmitters or receivers for the first time, if the same other standards are satisfied, the terminals within the coverage range of the one or more base stations have a higher priority of being selected as the opposite end than any other terminals.

Once the terminal and the base station having the service relationship are selected, the service may be triggered through two options.

Option 1: The service request (sensing service request information) is sent by the network function (NF) of the 5G core network to the selected base station through N2, and then the selected base station forwards the request to the selected one or more terminals through the RRC.

Option 2: The network function (NF) of the 5G core network sends a service request to the selected base station through N2, and sends a service request to the selected one or more terminals through N1.

Once the UE and the gNB having the service relationship are selected, there is direct communication between them for transmission of control signaling and/or sensing data.

According to some embodiments of the present disclosure, there is provided a communication device. The communication device includes:
a processor; and
a memory, configured to store an executable instruction by the processor;
where the processor is configured to, when running the executable instruction, implement the method applied to any embodiment of the present disclosure.

Among, the memory may include various types of storage media. The storage medium is a non-transitory computer storage medium, and after the communication device is powered down, the information stored on the storage medium can be continued to be memorized.

The processor may be connected to the memory by using a bus or the like, and is configured to read an executable program stored in the memory.

According to some embodiments of the present disclosure, there is further provided a computer storage medium, where the computer storage medium stores a computer-executable program, and when the executable program is executed by the processor, the method of any embodiment of the present disclosure is implemented.

With regard to the apparatus in the above embodiments, the specific manner in which the modules perform operations has been described in detail in the embodiments related to the method, which will not be described in detail here.

As shown in FIG. 20, an embodiment of the present disclosure provides a structure of a terminal.

With reference to the terminal 800 shown in FIG. 20, the present embodiment provides a terminal 800. The terminal may be specifically a mobile phone, a computer, a digital broadcast terminal, a message transceiver device, a game console, a tablet device, a medical device, a fitness device, a personal digital assistant, or the like.

Referring to FIG. 20, the terminal 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the terminal 800, such as operations associated with display, telephone calls, data communications, camera operations, and recording operations. The processing component 802 may include one or more processors 820 to execute instructions to perform all or part of the steps in the foregoing methods. Moreover, the processing component 802 may include one or more modules that facilitate the interaction between the processing component 802 and other components. For example, the processing component 802 may include a multimedia module to facilitate the interaction between the multimedia component 808 and the processing component 802.

The memory 804 is configured to store various types of data to support the operation of the terminal 800. Examples of such data include instructions for any application or method operating on the terminal 800, contact data, phonebook data, messages, pictures, videos, etc. The memory 804 may be implemented by any type of volatile or non-volatile storage device or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 806 provides power to various components of the terminal 800. The power component 806 may include a power management system, one or more power supplies, and other components associated with generating, managing, and distributing power for the terminal 800.

The multimedia component 808 includes a screen providing an output interface between the terminal 800 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touching, sliding, and gestures on the touch panel. The touch sensor may not only sense a boundary of a touching or sliding action, but also sense a duration and pressure associated with a touching or sliding action. In some embodiments, the multimedia component 808 includes a front camera and/or a rear camera. The front camera and/or the rear camera may receive external multimedia data when the terminal 800 is in an operation mode, such as a photographing mode or a video mode. Each of the front camera and the rear camera may be a fixed optical lens system or have focal length and optical zoom capability.

The audio component 810 is configured to output and/or input audio signals. For example, the audio component 810 includes a microphone (MIC) configured to receive an external audio signal when the terminal 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and the peripheral interface module, which may be a keyboard, a click wheel, a button, or the like. The buttons may include, but are not limited to, a home button, a volume button, a starting button, and a locking button.

The sensor component 814 includes one or more sensors to provide status assessments of various aspects of the terminal 800. For example, the sensor component 814 may detect an on/off state of the terminal 800, relative positioning of the components, such as a display and a keypad of the terminal 800. The sensor component 814 may further detect a position change of one component of the terminal 800 or the terminal 800, presence or absence of contact between the user and the terminal 800, an orientation or acceleration/deceleration of the terminal 800, and a temperature change of the terminal 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may further include an acceleration sensor, a gyroscope sensor, a magnetic sensor, a pressure sensor, or a temperature sensor.

The communication component 816 is configured to facilitate wired or wireless communication between the terminal 800 and other devices. The terminal 800 may access a wireless network based on a communication standard, such as Wi-Fi, 2G, or 3G, or a combination of them. In some embodiments, the communication component 816 receives a broadcast signal or broadcast related information from an external broadcast management system via a broadcast channel. In some embodiments, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In some embodiments, the terminal 800 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components for performing the methods described above.

In some embodiments, there is further provided a non-transitory computer-readable storage medium including an instruction, for example, a memory 804 including an instruction, and the instruction may be executed by the processor 820 of the terminal 800 to complete the above method. For example, the non-transitory computer-readable storage medium may be a ROM, a random access memory (RAM), a CD-ROM, a magnetic tape, a floppy disk, an optical data storage device, or the like.

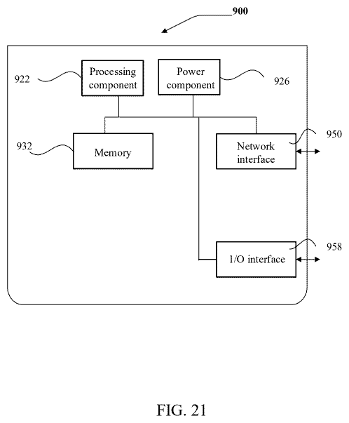

As shown in FIG. 21, an embodiment of the present disclosure shows a structure of a base station. For example, the base station 900 may be provided as a network side device. Referring to FIG. 21, the base station 900 includes a processing component 922 that further includes one or more processors, and memory resources represented by the memory 932 for storing an instruction, such as an application, that may be executed by the processing component 922. The application stored in the memory 932 may include one or more modules each corresponding to a set of instructions. In addition, the processing component 922 is configured to execute the instruction to perform any of the foregoing method applied to the base station.

The base station 900 may also include a power component 926 configured to perform power management of the base station 900, a wired or wireless network interface 950 configured to connect the base station 900 to a network, and an input/output (I/O) interface 958. The base station 900 may operate based on an operating system stored in the memory 932, such as Windows Server™, MAC OS X™, Unix™, Linux™, FreeBSD™, or the like.

Other embodiments of the present invention will be apparent to those skilled in the art from consideration of the description and practice of the present disclosure here. The present disclosure is intended to cover any variations, uses, or adaptations of the present invention following the general principles of the present invention and including the common general knowledge and conventional technical means in the art not disclosed in the present disclosure. The description and examples should be considered as examples only, and the true scope and spirit of the present invention are indicated by the following claims.

It will be appreciated that the present invention is not limited to the precise structure that has been described above and illustrated in the accompanying drawings, and that various modifications and changes may be made without departing from the scope of the present invention. The scope of the present invention is only limited by the appended claims.

1. A method for determining at least one of a transmitter or a receiver for a sensing service, wherein the method is performed by a network function, and the method comprises:
determining, based on a service relationship between a terminal and a base station, at least one of the transmitter and/or the receiver for performing the sensing service.

2. The method according to claim 1, wherein the service relationship comprises at least one of:
the base station being a serving base station of the terminal;
the base station being not the serving base station of the terminal;
the terminal being within a signal coverage range of the base station; or
the terminal being not within the signal coverage range of the base station.

3. The method according to claim 1, further comprising at least one of:
in response to the terminal being the transmitter, determining that the receiver is the base station;
in response to the base station being the transmitter, determining that the receiver is the terminal;
determining that both the base station and the terminal are transmitters; or
determining that both the base station and the terminal are receivers.

4. The method according to claim 3, wherein,
in response to the terminal being the transmitter, a priority that a serving base station of the terminal is determined as the receiver for performing the sensing service is higher than a priority of an alternative base station, wherein the alternative base station is not the serving base station of the terminal.

5. The method according to claim 4, wherein determining, based on the service relationship between the terminal and the base station, at least one of the transmitter or the receiver for performing the sensing service comprises at least one of:
in response to the base station being the serving base station of the terminal and the terminal being the receiver, determining that the base station is the transmitter;
in response to the base station being the serving base station of the terminal and the terminal being the transmitter, determining that the base station is the receiver;
in response to the base station being the serving base station of the terminal and the base station being the receiver, determining that the terminal is the transmitter;
in response to the base station being the serving base station of the terminal and the base station being the transmitter, determining that the terminal is the receiver;
in response to the base station being the serving base station of the terminal and the terminal being the receiver, determining that the base station is the receiver;
in response to the base station being the serving base station of the terminal and the terminal being the transmitter, determining that the base station is the transmitter;
in response to the base station being the serving base station of the terminal and the base station being the receiver, determining that the terminal is the receiver; or
in response to the base station being the serving base station of the terminal and the base station being the transmitter, determining that the terminal is the transmitter.

6. The method according to claim 4, further comprising:
in response to determining the receiver and the transmitter, triggering the sensing service.

7. The method according to claim 6, wherein triggering the sensing service comprises one of:
sending sensing service request information to the base station through an N2 message, wherein the sensing service request information is sent by the base station to the terminal through a radio resource control (RRC) message;
or,
sending sensing service request information to the base station through an N2 message, and sending the sensing service request information to the terminal through an N1 message.

8.-14. (canceled)

15. A communication device, comprising:
a memory; and
a processor, connected to the memory, and configured to, by executing a computer-executable instruction stored on the memory, implement a method for determining at least one of a transmitter or a receiver for a sensing service, wherein the method comprises:
determining, based on a service relationship between a terminal and a base station, at least one of the transmitter or the receiver for performing the sensing service.

16. A non-transitory computer storage medium, wherein the non-transitory computer storage medium stores a computer-executable instruction, and the computer-executable instruction is executed by a processor to implement a method for determining at least one of a transmitter or a receiver for a sensing service, wherein the method comprises:
determining, based on a service relationship between a terminal and a base station, at least one of the transmitter or the receiver for performing the sensing service.

17. The method according to claim 3, wherein, in response to the terminal being the receiver, a priority that a serving base station of the terminal is determined as the transmitter for performing the sensing service is higher than a priority of an alternative base station, wherein the alternative base station is not the serving base station of the terminal.

18. The method according to claim 3, wherein, in response to the base station being the transmitter, a priority that the terminal within a signal coverage range of the base station is determined as the receiver for performing the sensing service is higher than a priority of an alternative terminal, wherein the alternative terminal is not the terminal within the signal coverage range of the base station.

19. The method according to claim 3, wherein, in response to the base station being the receiver, a priority that the terminal within a signal coverage range of the base station is determined as the transmitter for performing the sensing service is higher than a priority of an alternative terminal, wherein the alternative terminal is not the terminal within the signal coverage range of the base station.

20. The method according to claim 3, wherein, in response to the terminal being the transmitter, a priority that a serving base station of the terminal is determined as the transmitter for performing the sensing service is higher than a priority of an alternative base station, wherein the alternative base station is not the serving base station of the terminal.

21. The method according to claim 3, wherein, in response to the terminal being the receiver, a priority that a serving base station of the terminal is determined as the receiver for performing the sensing service is higher than a priority of an alternative base station, wherein the alternative base station is not the serving base station of the terminal.

22. The method according to claim 3, wherein, in response to the base station being the transmitter, a priority that the terminal within a signal coverage range of the base station is determined as the transmitter for performing the sensing service is higher than a priority of an alternative terminal, wherein the alternative terminal is not the terminal within the signal coverage range of the base station.

23. The method according to claim 3, wherein, in response to the base station being the receiver, a priority that the terminal within a signal coverage range of the base station is determined as the receiver for performing the sensing service is higher than a priority of an alternative terminal, wherein the alternative terminal is not the terminal within the signal coverage range of the base station.

24. The communication device according to claim 15, wherein the service relationship comprises at least one of:
the base station being a serving base station of the terminal;
the base station being not the serving base station of the terminal;
the terminal being within a signal coverage range of the base station; or
the terminal being not within the signal coverage range of the base station.

25. The communication device according to claim 15, wherein the method further comprises at least one of:
in response to the terminal being the transmitter, determining that the receiver is the base station;
in response to the base station being the transmitter, determining that the receiver is the terminal;
determining that both the base station and the terminal are transmitters; or
determining that both the base station and the terminal are receivers.

26. The communication device according to claim 15, wherein the method further comprises:
in response to determining the receiver and the transmitter, triggering the sensing service.

27. The communication device according to claim 26, wherein triggering the sensing service comprises one of:
sending sensing service request information to the base station through an N2 message, wherein the sensing service request information is sent by the base station to the terminal through a radio resource control (RRC) message;
or,
sending sensing service request information to the base station through an N2 message, and sending the sensing service request information to the terminal through an N1 message.
